(19) United States
(12) Patent Application Publication
(10) Pub. No.: US 2025/0229608 A1
(43) Pub. Date: Jul. 17, 2025

(54) PROTECTIVE DEVICE FOR DOGS OR OTHER ANIMALS RIDING IN VEHICLES WITH HEADS PROTRUDING THEREFROM

(71) Applicant: Darrin Molloy, SAINT GERMAIN, WI (US)

(72) Inventor: Darrin Molloy, SAINT GERMAIN, WI (US)

(21) Appl. No.: 18/414,484

(22) Filed: Jan. 17, 2024

(51) Int. Cl. B60J 1/20

(52) U.S. Cl. CPC B60J 1/20

(57) ABSTRACT

A protective device is described which can be mounted to the window frame of a window on a vehicle to protect the face of an animal such as a dog when it extends its head out of the window during travel. The protective device protects the eyes and face from being struck by insects, small rocks, debris, or other flying objects. The protective device has a support frame covered by a screen or mesh that allows the rushing wind to pass through to contribute to the enjoyment of the animal, while shielding the face of the animal from potentially dangerous objects. In some aspects, the frame can be readily attached, secured, and removed with one or more connectors.

### FIELD OF THE DISCLOSURE

The present disclosure pertains to eye-protective shields on vehicles for protecting the eyes or faces of pets or other animals when their heads protrude from a vehicle window, including methods of manufacture and use.

### BACKGROUND

Many dogs and some other animals enjoy riding in vehicles with windows open enough for their head to protrude from the vehicle. Exactly why is a matter of debate, but possible explanations include the excitement being able to detect numerous odors in the rushing wind, the feel of the wind as it interacts with fur and ears, the ability to see much more of the passing environment with the wider view afforded by a protruding head, and so forth. Unfortunately, high air velocity can mean more than just exposure to many scents and scenes, for the wind may also hold insects, flying pebbles, and other debris. Some of these objects flying past a car can strike a dog in the face, sometimes causing serious injuries such as a lost eye. There is a need for improved eye protection that does not impede the enjoyment of an open window while the vehicle is moving. There is also a need for protective shielding that can be easily attached to and detached from a vehicle. In some aspects, there may also be a need for eye protective shielding that does not interfere with other passing vehicles or with safe operation of the vehicle to which the shielding is attached.

While the solutions discussed herein may address one or more of the previous problems noted here, it is not necessary for any aspect as claimed to resolve all or any of the various problems mentioned or alluded to herein in order to be within the scope of the claims.

### SUMMARY

Applicant has developed a protective device for protecting the eyes or face of a dog or other pet or animal when riding in a vehicle such as a car or truck with an open window. The protective device comprises a resilient support frame that defines an opening across which a screen is provided for blocking insects or debris that otherwise might strike the animal in the face when the animal's head protrudes from the moving vehicle. The resilient support frame can be firmly attached to the frame of a door on the vehicle, such as a rear passenger door or a front door, and may employ connectors such as straps, for example, that wrap around the leading edge of a window frame on the door and thereby secure the protective device against the door. The resilient support frame comprises a base and an outer portion that cooperates with the base to hold a screen in place. The base may be adapted to be anchored to the vehicle, and in some aspects may be secured against the vehicle with connectors such as one or more straps that hold the based firmly against a door frame. Such connectors can be made from fabric, plastic, or other flexible materials and may also include snaps, hook and loop attachments (e.g., patches of hook and loop material adapted to form a connection), ratcheting mechanisms and the like that can be used to secure the connectors in place (in some aspects, by connecting one portion of a connector to another portion of the connector) and apply sufficient pressure to make the base firmly anchored in place to hold the resilient support frame.

The resilient support frame may be made of any suitable durable material such as plastic (e.g., rods, tubes, etc.), wood, metal such as aluminum, steel, fiberglass, composite materials, of combinations of any of the materials cited herein, and so forth. The outer portion of the frame may have a cross-section that is square, rectangular, circular or oval, or has a rounded square or rectangle, an I-beam, an aerodynamic shape such as a tear-drop cross-section or other curved geometry, etc. The cross-section need not be constant throughout any element of the resilient support frame but may vary with position in order to provide reduced wind resistance, improved safety, desired strength or other performance criteria, etc. In some aspects, the components of the resilient support frame may each have aerodynamic contours or cross-sections to reduce drag.

The resilient support frame is adapted to be attached to or secured against the frame of a car such as the frame of a door or the frame of the door. The resilient support frame attaches to the vehicle in a manner that allows the frame and particularly the outer portion of the frame to extend outward from the vehicle while being securely anchored in place though attachment of the base to the vehicle by devices such as clamps, straps, cable ties, suction cups, hook and loop systems, magnets such as magnetic strips, removable adhesive, etc.

The outer portion of the resilient support frame may extend substantially at a right angle from (or normal to) the frame of the door or of the car itself to which the frame is attached, or may be at an angle that is less than 90 degrees from the plane of whatever portions of the body or frame of the car that it is attached to. For example, a resilient support frame that is substantially planar may project from the surface of the car at an angle of about 90 degrees such as from 40 degrees to 100 degrees, from 45 degrees to 90 degrees, from 50 degrees to 85 degrees, from 60 degrees to 80 degrees, or from 50 degrees to 75 degrees. (Note that when multiple ranges are given as alternatives, it should be understood for the purposes of the present disclosure to explicitly disclose any suitable or reasonable combination of any of the lower ranges with any of the upper ranges. Thus, the disclosure of a lower angle such as 45 degrees and the disclosure of a higher angle such as 75 degrees should be understood to provide specific support for the frame being at an angle of 45 to 75 degrees, even if that specific combination was not explicitly listed.)

In some aspects, the resilient support frame may be deflected from its position as the wind speed relative to the vehicle increases as the force of wind drag bends or rotates the frame relative to an axis through the base. For example, in some aspects, the resilient support frame may extend from the surface of a door frame at an angle of about 80 to 90 degrees from the plane of the door frame where attached, but as vehicle speed increases to, say, 50 miles per hour, the force of the wind on the frame and the screen may cause further deflection to bend the resilient support frame such that the angle the outer portion of the resilient support frame forms relative to the portion of the frame of the car that contacts the base or relative to the window of the door it is attached to may be somewhat less such as from 70 to 80 degrees, or, in other words, about 10 degrees less. In other aspects, the resilient support frame may deflect by about 5 degrees to 20 degrees when the wind speed relative to the vehicle (in a direction opposite to the direction of motion of the vehicle) is, say, from 45 miles per hour to 60 miles per hour or is 50 or 60 miles per hour.

Various attachment methods may be employed. One primary method involves the use of adjustable straps, which can be fastened around the car window or door frame. These straps may incorporate hook and loop fasteners, offering ease of use and quick adjustment capabilities. Additionally, for enhanced security and tension control, some straps are equipped with a ratcheting mechanism, allowing for precise tightening. Other attachment options include the use of suction cups for a temporary yet strong hold, or clamping systems that can be adjusted to fit various window sizes and shapes. In some aspects, the resilient support frame is provided with more than one attachment method to be suitable for a wide range of vehicles, ranging from small cars to larger trucks, thereby ensuring that the frame is not only easy to install but also remains stable and secure during use.

The screen may be or may comprise a fiberglass, metal, or polymeric screen such as an 18×16 fiberglass screen in which the fiberglass typically has a vinyl coating. Such a screen has 18 wires per inch in one direction and 16 wires per inch in the other direction, with an open area of about 59%. Wire diameters may be, for example, about 0.008 inches, 0.011 inches, 0.017 inches, 0.02 inches, 0.03 inches, etc. or any suitable diameter or effective diameter such as from 0.005 to 0.035 inches. The wires may be monofilaments of polymer, multicomponent polymer elements, metal wires such as stainless steel, bronze, aluminum, etc. The screen itself may be flexible like a textile web, capable of draping over the hand, or may be substantially stiff, capable of maintaining a three-dimensional shape once given that form regardless of how it is oriented with respect to gravity. The open area between the wires or other mesh elements may be, for example, at least 30%, 40%, 50%, or 55%, such as from 30% to 90%, 40% to 80%, 50% to 85%, etc.

The characteristic open area in the screen may have a width and/or a height of, for example, 0.02 to 0.25 inches, such as from 0.02 to 0.2 inches, 0.03 to 0.15 inches, 0.03 to 0.12 inches, 0.03 to 0.1 inches, 0.03 to 0.08 inches, or from about 0.035 to 0.07 inches. These dimensions may also apply to a characteristic diameter of the openings of the screen, which can be taken as the diameter D that would give a circle having the same area as the open area of a characteristic opening for the screen. Thus, a characteristic rectangle of, say, 0.047 inches by 0.06 inches would have an effective diameter of 0.06 inches, while a rectangle of 0.2 inches by 0.10 inches would have an effective diameter of 0.16 inches. In related aspects the screen is substantially free of openings greater than 1.3, 1.5, 1.7, 1.9, 2, or 2.5 times the size of the characteristic diameter. In some aspects, the screen over the open area within the support frame is substantially free of openings greater than 0.2, 0.4, 0.5, or 0.6 inches in width. In related aspects, the central 50% of the area of the screen over the open area within the support frame is substantially free of openings greater than 0.2, 0.4, 0.5, or 0.6 inches in width.

Further examples of screen materials include those made by Phifer, Inc. (Tuscaloosa, AL) such as Phiher 18×16 Standard Window Screen Mesh, reported to have a light transmission of 69%, open area of 59%, a fabric thickness of 0.0125 inches, a burst strength of 92 psi. Also to be considered is the 18×16 plain weave aluminum mesh sold by STG (Screen Technology Group, Washougal, WA) made from 5154 aluminum alloy with an open area of 66.08%, apertures of 0.0445″×0.0515 in (1.13 mm×1.30 mm) with a wire diameter of 0.011 in (0.279 mm) and a basis weight of 3.56 lbs/100 ft². Another example is 16 mesh copper wire with a wire diameter of 0.0180 in (0.4572 mm), apertures that are 0.044 in wide (11.1176 mm) and an open area of 50%. And thickness of 0.0360 in (0.9144 mm). For increased airflow and reduced risk of very small insects passing through the screen, a 20×20 mesh or 18×18 mesh with 0.008 in wires may be considered, for example. For a sturdier screen, a 17×14 mesh with a wire diameter of 014 in may be considered.

In some aspects, a mesh may be formed by techniques other than weaving wires together. For example, a polymer or other durable solid may be molded, extruded, or subjected to subtractive manufacturing to remove material in order to form a continuous non-woven “screen” with numerous openings that perform as a mesh to let light and air pass through. The polymer may be transparent, and in some aspects the solid portions of the mesh may provide a substantially flat surface that provides good transmissivity for light, somewhat reducing the potential disruption of the view by the screen. The open area of the mesh or screen may be at least 30%, 40%, 50%, or 60%, such as from 35% to 70%, 30% to 75%, etc.

In some aspects, the screen may comprise a woven textile that is substantially free of metal wires, and may have a characteristic opening size or characteristic diameter of at least 0.016, 0.02, or 0.03 inches, for example.

Wires may be secured to the frame by folding around the frame and being attached to themselves using adhesive, solder, etc., or may be clipped onto or mechanically attached to the frame.

In some aspects, the support frame may comprise LED lights or other light sources to add aesthetic effects. In some aspects, the frame may also be adapted to blink in sync with blinking turn signals of the car, which may be achieved through a Bluetooth or other electronic connection, wireless or wired. Batteries, if needed, may be disposed in the base or elsewhere.

In other aspects, screens may be printed, painted, or otherwise adorned with logos or other personalized images to add interest and appeal to the protective device. The support frame may also be customized in similar ways and may have imagery or coloration matching the printing or painting on the screen.

Thus, in a first aspect, a protective device is disclosed that is mounted on a vehicle to protect the face of an animal from injury during travel when the head of the animal extends from the window of a door of the vehicle, the protective device having a support frame that holds a screen, wherein the frame has an inner portion and an outer beam, the inner portion having one or more extensions extending from the inner portion for holding the frame normal to the door of the vehicle, and further having one or more connectors for connecting the support frame to the vehicle, wherein the frame extends at least 8 inches away from the vehicle. In related aspects, the frame has a width, the distance it extends away from the vehicle of at least 6 inches, 8 inches, or 10 inches, and a height, the vertical span of the frame as mounted on a vehicle, or at least 6 inches, 8 inches, 10 inches, or 12 inches, and may have any useful combination of width and height such as 8 inches by 10 inches, 9 inches by 11 inches, 10 inches by 10 inches, 10 inches by 12 inches (width being the first given dimension).

In a second aspect, the protective device of Aspect 1 further has one or more openings in the inner portion of the support frame adapted to cooperate with the one or more connectors for holding the frame against the door of the vehicle.

In a third aspect, the protective device of Aspect 1 is disclosed, wherein the connectors have one or more straps adapted to wrap around a portion of the door frame that also pass through the one or more openings of the inner portion of the support frame.

### BRIEF DESCRIPTION OF THE FIGURES

FIG. 1 depicts a perspective view of a protective device.

FIG. 2 depicts a partial view of the protective device attached to a vehicle for protection of a dog.

FIG. 3 depicts another aspect of a protective device having a substantially rectangular shape.

FIG. 4 depicts an aspect of a D-shaped protective device.

FIG. 5 depicts a vehicle in which one aspect of a protective device is serving to protect the face of a dog.

FIG. 6 depicts an aspect of a protective device having a substantially triangular shape.

FIGS. 7A-7D show cross-sections of the base of a protective device showing its relationship to the screen.

FIG. 8 depicts another form of the frame of the protective device.

### DETAILED DESCRIPTION

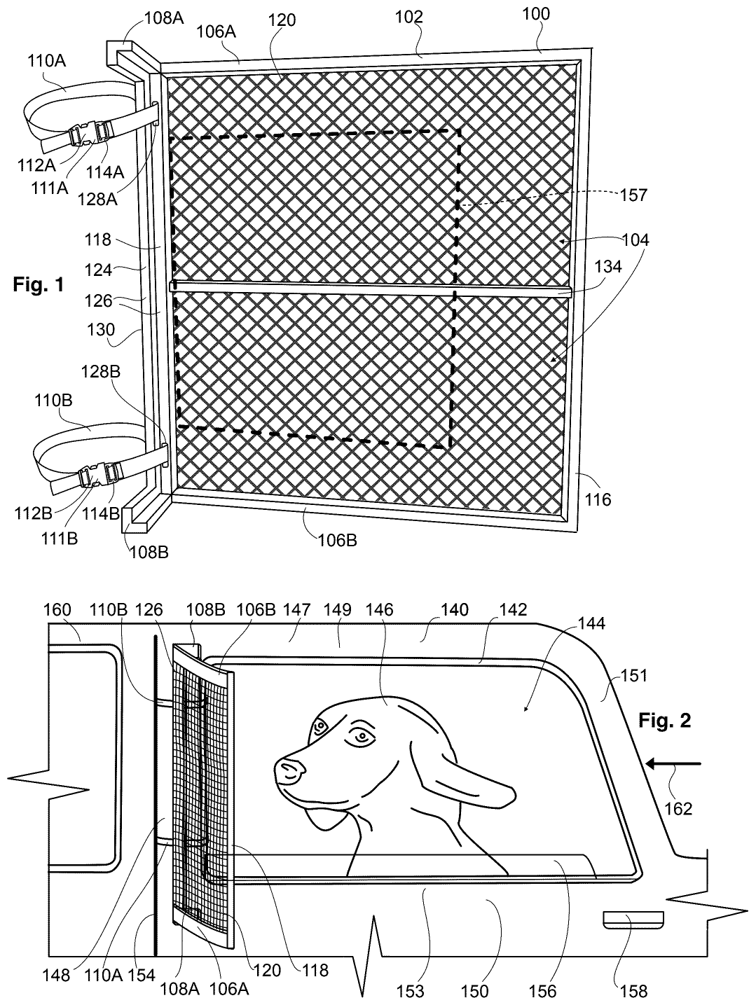

FIG. 1 depicts a perspective view of a protective device 100 for protecting pets during vehicular transport. The protective device 100 comprises a support frame 102 having an open region 104 across which a screen is stretched, such that the screen 120 can serve as a protective barrier that allows air to flow through the protective device 100 while preventing debris or insects from striking the face of pet (not shown) whose head may protrude from a window (not shown) of the vehicle. The support frame 102 as shown in this aspect comprises a first side 106A, an opposing second side 106B, an outer beam 116, and an inner beam 118 that is attached to or integral with a base 124. The base 124 provides support for the support frame 102 against the outer surface of a vehicle (not shown). The inner surface 130 of the base 124 may directly contact the vehicle, or may be cushioned by a layer of a deformable material (not shown) such as rubber, neoprene, foam, silicone, and the like. Support is also provided by the extensions 108A, 108B, arising from the base 124, which may act as feet to resist the torsion generated by wind acting on the protective device 100 to stabilize it. (In some aspects, as shown, there are two extensions 108A, 108B disposed at opposing ends of the base 124, but in other aspects the extensions 108A, 108B may be elsewhere along the base 124 or may extend across much of the base 124 and may be joined together.) Support is particularly provided by the straps 110A, 110B that connect the protective device 100 firmly to the frame of the car (not shown). The straps 110A, 110B pass through respective openings 128A, 128B in the inner beam 118 as shown or alternately, through the base 124 or a gap between the base 124 and the inner beam 118. In some aspects, the inner beam 118 and the base 124 may be integrally formed rather than being separate elements that have been joined together as shown. Collectively, including the extensions 108A, 108B of the base 124, they form the inner portion 126 of the protective device 100.

In some aspects, the straps 110A, 110B may pass through the inner portion 126 or otherwise engage with the inner portion 126 to hold it firmly against the vehicle (not shown). Considering the first strap 110A, which in this aspect is substantially identical to the second strap 110B, the first strap 110A may be secured by any known means such as a quick release snap 111A, 111B shown here in the form of such as plug and receptacle connector (or interlocking connectors) having a plug 114A attached to one end of the first strap 110A and a receptacle 112A attached to the second end of the strap 110A, wherein the receptacle 112A can receive and retain the plug 114A. The strap 110A can be tightened by adjusting the position of the receptacle 112A and/or the plug 114A on the strap. In alternate aspects, the strap 110A may be secured and tightened using other systems (not shown) such as a prong and hole connection similar to a traditional belt buckle, snap-on connections, hook and loop connections (e.g., one portion of the strap has a layer of hook-like material and another portion has a has a layer of loop material, such that the two can engage to form a secure adjustable connection), ratcheting mechanisms (e.g., ratchet and pawl, with a portion of the strap wound around the pawl), and other known attachment mechanisms. Similar principles apply to the second strap 110B and its quick release snap 111B with its plug 114B attached to one end of the second strap 110B and a receptacle 112B attached to the second end of the second trap 110B. In some aspects, one strap 110A may be sufficient and no second strap 110B is present. In other aspects, more than two straps may be used.

The straps 110A, 110B are adapted to tighten the protective device 100 on the exterior of an automobile with the straps 110A, 110B wrapping around the door frame adjacent the opening of the window to secure the protective device in an upstream location for a dog at the window with a head that may at least occasionally protrude from the window.

The support frame 102 as shown may have a reinforcing bar 134 connecting the outer beam 116 with the inner beam 118 or any the sides of the frame 106A, 106B, or any two portions of the support frame 102 to reinforce the frame. It may have dimensions similar to other elements of the frame or may be greater or smaller in any dimension of its cross-section.

The screen 120 may be attached to the support frame 102 in any suitable way, such as by clamping mechanisms (e.g., by clamping a portion of the screen between two flat surfaces that may comprise one or more portions of the support frame 102), staples, adhesives, hook and loop connectors, screws, cable ties, clips, braces, wrapping around a portion of the support frame 102, being embedded in plastic or resin, restrained by hooks or latches, etc. The screen 120 may be fixedly attached to all sides of the support frame 102 such as all four sides when the support frame 102 has four sides as depicted (aspects that do not have four distinct sides such as one straight side joined to an arc, three sides, five sides, etc., are also contemplated), but may also be relatively unattached on one or more sides. Thus, for example, in the protective device 100 shown, the screen 120 could, in one aspect, be fixedly attached to the outer beam 116, the first side 106A and the second side 106 B, and optionally to the reinforcing bar 134 or other cross-beams, while not being anchored on the inner beam 118 or on the base 124. In such an aspect, one edge of the screen 120 may be unattached, but could still be held in place by the other regions of attachment. In other aspects, portions of the screen 120 may be molded into plastic or other materials to be anchored into one or more portions of the support frame 102.

As depicted, the screen 120 is disposed on the front or windward side of the support frame 102. In other aspects, the screen 120 or a portion thereof may be fixed on a downwind surface of one or more elements of the support frame 102, or may not be in contact with either a windward or downwind side of one or more elements of the support frame 102, but may be joined to an interior region such as being clamped between two halves or portions of the beams or other materials forming the first side 106A, the second side 106B, the outer beam 116, the inner beam 118, and/or the reinforcing bar 134 of the support frame 102. In some aspects, the screen 120 may be in contact with both a windward and downwind side of an element of the support frame 102, such as wrapping around the first side 106A and/or the second side 106B.

The reinforcing bar 134 is depicted as a cross-beam joining the outer beam 116 and the inner beam 118, but many other configurations may be considered, such as one or more diagonal beams or struts (not shown) connecting corners or other regions of the support frame 102, or a cross-beam joining the first side 106A to the second side 106B, etc. More than one reinforcing bar 134 may also be used.

An interior region 157 of the screen 120 is marked to indicate a region occupying about 50% of the open area withing the open region 104 inside the support frame 102, being adjacent to the inner beam 118 but away from the first edge 106A, the second edge 106B, and the outer beam 116. In some aspects, the interior region 157 may be considered when determining if there are openings greater than, say, 0.2 inches, 0.3 inches or greater in terms of a width or effective diameter in a region that might pose particular safety risks.

FIG. 2 depicts a partial view of the protective device 100 attached to a vehicle 140 for the protection of a dog 146 or other animal as it extends its head through the window 144 within a window frame 147 of a rear passenger door 150 in the vehicle 140 as it travels in a direction shown by arrow 162. The glass pane 156 associated with the window 144 is lowered such that the glass pane 156 is below the first strap 110A. The door may be opened (when the vehicle 140 is at rest) by opening the door handle 158. The protective device 100 is attached to the rear passenger door 150, and in particular to the window frame 147. The window frame 147 has an inner edge 142 that can receive the glass pane 156 (particularly when the window 144 is closed as the glass pane is fully raised) and is surrounded with structural elements including the leading edge 148, the top edge 149, the trailing edge 151, and the lower edge 153 which is part of the body of the rear passenger door 150. The protective device 100 is most specifically attached to the leading edge 148 of the window frame 147, which is near the door hinge (not shown) and door jamb (not shown) of the door, and adjacent the gap 154 between the rear passenger door 150 and the adjacent front door 160. The protective device 100 is held in place by a first strap 110A and a second strap 110B that wrap around the leading edge 148 of the window frame 147 such that the strap passes over the external (visible) portion of the leading edge 148 of the window frame 147, through the gap 154 and behind the leading edge 148 and over the inner edge 142 of the window frame 147 to pass through the openings 128A, 128B (not visible from this angle) which may be slots or openings of various shapes. The quick release snaps 111A, 111B or other connectors are not shown (e.g., they may be against the inner side of the leading edge 148 of the window frame 147).

The extensions 108A, 108B are urged against the rear passenger door 150 and provide resistance against the protective device 100 tipping over under the load created by air pressure when the car is traveling rapidly. The porous nature of the screen 120 helps relieve the force of air pressure to prevent excessive stresses at high speed while also providing the satisfaction of the rush of wind over the face of a dog or other animal, while also protecting the animal from injury. In some aspects, the presence of a mirror on the side of a front door in front of the protective device 100 can also provide benefits in terms of creating a wake that can reduce wind pressure on the protective device 100 and assist in slowing or deflecting debris.

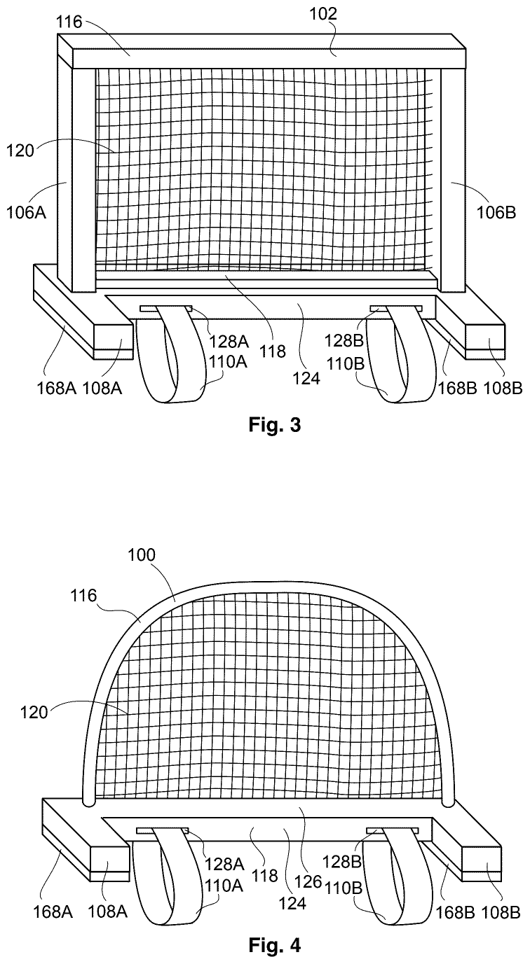

FIG. 3 depicts another aspect of the protective device 100. Shown here is a base 124 with a deformable layer 168A, 168B attached respectively to the extensions 108A, 108B to reduce the risk of damage to the exterior surface of the vehicle 140 (not shown) and to provide a good grip. In this aspect, the screen 120 is shown to be embedded in the material of the sides 106A, 106B, here visible for the first side 106A. The shape of the support frame 102 is substantially rectangular.

FIG. 4 shows another aspect of the protective device 100 in which the shape of the support frame 102 resembles the letter D. This D-shaped aspect of a protective device 100 also lacks the reinforcing bar 134 of FIG. 1. The base 124 and inner beam 118 are integrated and provide openings 128A, 128B in the form of slots, as shown here, through which the first and second straps 110A, 110B, respectively, can pass to secure the protective device 100 in place on a vehicle 140 (not shown). In this aspect, the outer beam 116 has an arc-like shape that can eliminate the need for separate side pieces such as the first and second sides, 106A, 106B, of FIGS. 1-3. Rather, one curved beam may serve the outer beam 116 that also connects directly to the inner portion 126 which comprises the integrated base 124 and inner beam 118. The curved outer beam 116 may comprise plastic or metal tubing that enters a void in the inner portion 126 of the protective device 100, further secured by a bolt, adhesives, etc.

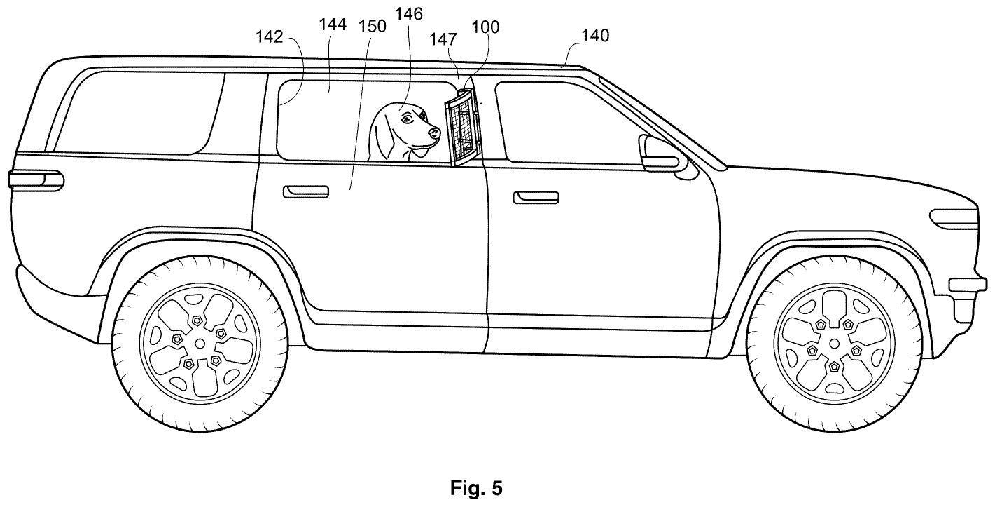

FIG. 5 depicts a vehicle 140 having a rear passenger door 150 with a window 144 and window frame 147 to which a protective device 100 is attached to protect the face of a dog 146 or other animal whose head may be extended out the window 144.

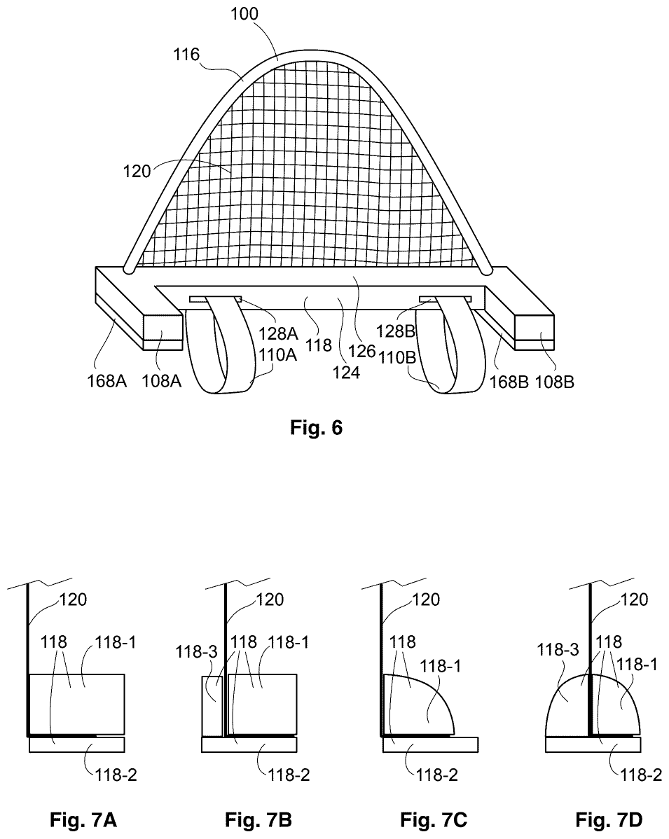

FIG. 6 depicts a protective device 100 having a substantially triangular shape. As in FIG. 4, the aspect of the protective device 100 shown here comprises a base 124 and inner beam 118 that are integrated into a common element, the inner portion 126 of the protective device 100, which provides openings 128A, 128B in the form of slots through which the first strap 110A and the second strap 110B, respectively, can pass.

FIGS. 7A-7D depict cross-sections of the base 124 and the adjacent lower portion of the screen 120 showing examples of some of the ways the screen 120 may be connected to or secured against the base 124. FIG. 7A shows the inner beam 118 having an upper first portion 118-1 and a lower second portion 118-2, with the screen 120 disposed between the two where it may be clamped, glued, or otherwise restrained against the inner beam 118. The first portion 118-1 has a rectangular cross-section in this aspect. The position of the screen 120 in FIGS. 7A-7D may be taken to be on the windward side or downward side of the protective device 100 (not shown).

FIG. 7B shows the inner beam having a first portion 118-1, a lower second portion 118-2, and a third portion 118-3 such that the screen 120 extends vertically between the third portion 118-3 and the first portion 118-1. The first portion 118-1 is substantially rectangular in this aspect.

FIG. 7C is similar to FIG. 7A except the first portion 118-1 is more rounded, such as a quarter or a circle.

FIG. 7D combines the rounded first portion 118-1 of FIG. 7C with a rounded third portion 118-3, with the screen 120 extending vertically between the first portion 118-1 and the third portion 118-3, while also restrained below by the second portion 118-2. The portions 118-1, 118-2, and 118-3 of the inner beam 118 may all be of the same material or different materials, such as plastic (polycarbonate, acrylonitrile butadiene styrene, PET, PVC, PVDC, polyurethane, polyolefins such as PP or HDPE, polysulfones, nylon, etc.), wood, metal, silicone, rubber, composite materials, graphite, fiberglass, fiberglass-reinforced plastics, etc., or any combination thereof.

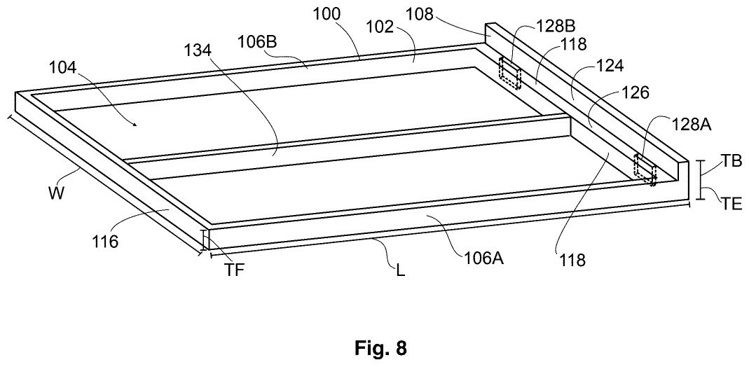

FIG. 8 depicts another form of the support frame 102 of a protective device 100 with the screen not shown in the open region 104 and the straps also not shown. The support frame 102 comprises an outer beam 116, an opposing inner beam 118 adjacent a base 124, a first side 106A, a second side 106 B, and a reinforcing bar 134. In this aspect, there are not two spaced apart extensions as in previously depicted aspects, but a single extension 108 that extends from the base 124 such that the base 124 is more elevated in the orientation shown than the inner beam 118. In other words, the base 124 has a thickness TB which in this aspect is also the thickness TE of the extension 108, and these thicknesses TB, TE are substantially greater than the thickness TF of the remaining components of the support frame 102. Here the thickness TF is the thickness of the outer beam 116, the first side 106A, the second side 106B, the reinforcing bar 134, and the inner beam 118, though no two of these components must necessarily have the same thickness and the thickness need not be uniform across any of these components, though it is shown to be uniform here. But the first and second sides 106A, 106B, for example, may be tapered such that near the base 124 the thickness is greater than at the outer beam 116. The various components of the support frame 102 such as the first and second sides 106A, 106B or the reinforcing bar 134 may also be curved to some degree rather than linear as shown.

The openings 128A, 128B in the inner portion 126 are shown here as slots passing through the thickness of the inner beam 118 adjacent to the base 124 or, equivalently in this aspect, to the extension 108. Thus the openings 128A, 128B in the inner portion 126 for receiving straps (not shown), ties, cables, or other connection systems extend through a thickness TF in this aspect.

In some aspects, the protective device 100 as shown has a width W and a length L that each may range, by way of example, from 6 inches to 20 inches, such as from 6 inches to 15 inches, 8 inches to 14 inches, 8 inches to 12 inches, etc. L and W may be substantially the same, such as about 10 inches by 10 inches or 14 inches by 14 inches, but may have ay suitable ratio L/W such as from about 0.5 to 1.5, 0.8 to 1.25, 0.6 to 1.5, less than 1, greater than 1, from 0.9 to 1.8, from 0.5 to 1.1., from 0.7 to 1.4, from 0.5 to 1.3, etc. The inverse ratio, W/L, may also have any of the enumerated values described for W/L.

The thickness TE of the extension 108 (or extensions in other aspects) may be, for example, from 2 inches to 7 inches, such as from 2.5 inches to 5 inches, 2.5 inches to 4.5 inches, 3 inches to 6 inches, etc. The thickness TF of the support frame 102 (which here excludes the thickness TB of the base and the thickness TE of the extension 108) may be from about 1 inch to 4 inches, from 0.5 inches to 4 inches, from 0.5 inches to 3 inches, and from 1 inch to about 2.5 inches. The ratio TE/TF may range from about 1 to 10, such as from 1.5 to 10, from 2 to 10, from 2 to 6, from 2 to 4, and from 2.5 to 5.

### Further Considerations: The Wind Velocity Reduction Factor

In some aspects, the presence of the rushing wind over the face of an animal may be an important factor contributing to the enjoyment of riding in a vehicle with an open window. The use of a screen as a barrier will reduce the wind velocity somewhat. To better understand the impact of the screen in reducing wind velocity, a series of experiments were conducted with an anemometer to measure how a standard 18×16 fiberglass screen could reduce wind velocity. Rather than using a wind tunnel, a leaf blower was used capable of delivering a strong current of air at velocities similar to those experienced on the highway.

To estimate the expected wind velocity reduction that may be caused by the presence of the screen of the protective device mounted in the air stream passing over an automobile, a wind anemometer was mounted behind a standard 16×18 fiberglass screen held within the frame of a standard screen door with a single reinforcing bar across the middle of the door. The door was oriented sideways on a table, position at an angle of 15 degrees from vertical, thus tipped slightly way from the air source (i.e., the top edge of the door was slightly away from the air source while the bottom edge of the horizontal door was slightly closer to the air source). The air source was an EGO power Blower 530 CFM cordless leaf blower made by EGO Power Company (Naperville, IL), model LB5302 using an ARC 56B lithium battery. The leaf blower was positioned horizontally in front of the screen, with the center of the nozzle about six inches above the level of the table holding the screen door.

The digital anemometer employed was the HoldPeak HP-866B Pro Anemometer made by HoldPeak Corp. (Zhuhai, China). The anemometer was aligned with the leaf blower nozzle 12 inches behind the screen along the centerline between the center of the nozzle and the center of the anemometer vane, with the distance from the screen to the end of the leaf blower nozzle being set to 2 feet, 4 feet, 6 feet, or 9 feet. The leaf blower was operated variously in normal or turbo mode. The anemometer was operated in peak velocity mode such that the recorded velocity was the maximum air velocity experienced during a trial. Trials lasted about 5 seconds each and were repeated at least three times per condition. Trials were conducted with the screen door in place and with it removed, so the effect of the screen on the measured wind velocity could be determined. In additional tests, results were also compared with the anemometer at both 12 inches and 6 inches behind the screen, with no discernible difference in velocity reduction. Table 1 shows the results.

TABLE 1
Wind Velocity Reduction Factor (WVRF) data: comparison
of measured velocities with and without a standard
screen present in front of the anemometer

| | V, mph, no | V, mph, | ΔV, | WVRF (% |
|---|---|---|---|---|
| Distance | screen | screen | mph | reduction) |
| 9 | 12.30 | 7.23 | 5.08 | 41.3% |
| 9 | 20.03 | 12.33 | 7.71 | 38.5% |
| 6 | 19.10 | 12.49 | 6.61 | 34.6% |
| 6 | 28.60 | 22.07 | 6.53 | 22.8% |
| 4 | 25.57 | 16.15 | 9.42 | 36.8% |
| 4 | 41.60 | 26.07 | 15.53 | 37.3% |
| 6 | 18.33 | 12.30 | 6.03 | 32.9% |
| 2 | 38.08 | 26.67 | 11.41 | 30.0% |
| 2 | 64.17 | 44.60 | 19.57 | 30.5% |

| | |
|---|---|
| Average | 33.9% |

Velocities without the screen present ranged from 12 to 64 mph, and were reduced by 20 to 40% with an average of 33% reduction by the screen. This range of velocity reduction is believed to represent a suitable range for maintaining the excitement that a dog experiences when exposed to an intense variety of odors rushing by and/or the enjoyment of wind rushing over the face and fur of the dog or other animal. Thus, in some aspects, the protective device 100 provides a velocity reduction behind the screen at a car velocity of 60 mph in otherwise substantially still air of less than 65%, less than 50%, or less than 45%, such as from 18% to 44%, from 20% to 40%, or from 25% to 40%. In other aspects, such results may be seen instead or in addition at other velocities such as at 12 mph, 20 mph, 30 mph, 40 mph, 45 mph, 50 mph, or 64 mph. Such a measure of velocity reduction may be termed the Wind Velocity Reduction Factor.

There are advantages to having some velocity reduction, such as a Wind Velocity Reduction Factor of at least 18%, 20%, or 25%, for the reduced velocity reduces risk of injury should fine particles make it through the screen, for example. The open area of the screen with its wind velocity reduction properties is believed to provide a useful balance between safety and enjoyment for the animal.

### FURTHER REMARKS

When introducing elements of aspects of the invention or the embodiments thereof, the articles “a,” “an,” “the,” and “said” are intended to mean that there are one or more of the elements, and thus may include plural referents unless the context clearly dictates otherwise. The terms “comprising,” “including,” and “having” are intended to be inclusive and mean that there may be additional elements other than the listed elements.

As used herein, the word “exemplary” means serving as an example, instance, or illustration. The aspects described herein are not limiting but rather are exemplary only. It should be understood that the described aspects are not necessarily to be construed as preferred or advantageous over other aspects. Unless otherwise indicated, no aspect of any invention described herein should be assumed to have the same advantages or features had by any other aspect.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative aspects, these examples should not be construed as limitations. The inventive system, methods, and products can be adapted for other uses or provided in other forms not explicitly listed above, and can be modified in numerous ways within the spirit of the present disclosure. Thus, the present invention is not limited to the disclosed aspects, but is to be accorded the widest scope consistent with the claims below.

We claim:

1. A protective device mounted on a vehicle to protect the face of an animal from injury during travel when the head of the animal extends from the window of a door of the vehicle, the protective device comprising a support frame that holds a screen, wherein the frame comprises an inner portion and an outer beam, the inner portion comprising one or more extensions extending from the inner portion for holding the frame normal to the door of the vehicle, and further comprising one or more connectors for connecting the support frame to the vehicle, wherein the frame extends at least 8 inches away from the vehicle.

2. The protective device of claim 1, further comprising one or more openings in the inner portion of the support frame adapted to cooperate with the one or more connectors for holding the frame against the door of the vehicle.

3. The protective device of claim 2 wherein the connectors comprise one or more straps adapted to wrap around a portion of the door frame that also pass through the one or more openings of the inner portion of the support frame.

4. The protective device of claim 3 wherein the straps are cooperatively associated with quick-release snaps.

5. The protective device of claim 1 having by a Wind Velocity Reduction Factor at 40 mph of at least 18%.

6. The protective device of claim 5 characterized by a Wind Velocity Reduction Factor at 60 mph of at least 25%.

7. The protective device of claim 5 characterized by a Wind Velocity Reduction Factor at 60 mph of from 20% to 50%.

8. The protective device of claim 5 characterized by a Wind Velocity Reduction Factor at 20 mph of at least 20%.

9. The protective device of claim 1, wherein the Wind Velocity Reduction Factor of the screen is less than 50% for wind velocities from 20 to 60 miles per hour.

10. The protective device of claim 1, wherein the screen is characterized by openings less than 0.2 inches in width.

11. The protective device of claim 1, wherein the screen is characterized by openings less than 0.15 inches in width.

12. The protective device of claim 1, wherein the support frame defines an open area and wherein an internal area of the screen occupying 50% of the open area of the frame is substantially free of openings greater than 0.2 inches.

13. The protective device of claim 1, wherein the screen comprises woven wires having at least one material selected from the group consisting of fiberglass, a metal wire, and a polymer.

14. The protective device of claim 1, having an open area of from 30% to 80%.

15. The protective device of claim 1, having an open area of from 49% to 80%.

16. The protective device of claim 1, wherein the support frame has a substantially rectangular shape and comprises a deformable material to protect the surface of the vehicle when in contact with the protective device.

17. The protective device of claim 1, wherein the support frame is substantially D-shaped or triangular.

18. The protective device of claim 1, wherein the support frame comprises a reinforcing beam to support the screen.

19. The protective device of claim 1, wherein the height of the support frame as mounted on the vehicle has a vertical dimension of at least 8 inches.

20. s The protective device of claim 1, wherein the one or more connectors comprise one or more of the group consisting of snaps, hook and loop material, and ratcheting mechanisms.
